(19) United States
(12) Patent Application Publication
(10) Pub. No.: US 2012/0238152 A1
(43) Pub. Date: Sep. 20, 2012

(54) DISTRIBUTOR BLOCK

(75) Inventor: Heiko Neumetzler, Berlin (DE)

(73) Assignee: ADC GMBH, Berlin (DE)

(21) Appl. No.: 13/512,816

(22) PCT Filed: Jun. 17, 2010
(86) PCT No.: PCT/EP10/03651

§ 371 Date: May 30, 2012

(30) Foreign Application Priority Data
Nov. 30, 2009 (DE) 10 2009 056 295.8

(51) Int. Cl. H01R 24/62

(52) U.S. Cl. 439/676

(57) ABSTRACT

The invention relates to a distribution strip (1) for telecommunications and data engineering comprising a housing and core connecting contacts (41, 51), first core connecting contacts (41) being accessible from a top side of the housing and second core connecting contacts (51) from a bottom side of the housing, the first and second core connecting contacts (41, 51) being part of one-piece first and second contact elements (40, 50) respectively which each comprise a connecting web (42, 52) and a contact leg (43, 53), a contact leg (43) of a first contact element (40) and a contact leg (53) of a second contact element (50) in each case forming an isolating contact, the core connecting contacts (41, 51) lying in line in one plane (E1), the contact legs (43, 53) being arranged in such a way that the plane (E1) of the core connecting contacts (41, 51) is at an acute angle to a plane (E3) of the contact legs (43, 53).

The invention relates to a distribution strip for telecommunications and data engineering.

WO 2009/127315 A1 discloses a distribution strip or connection module for telecommunications and data engineering having a module housing in which contact elements are arranged for the purpose of connecting cores on a cable side to cores on a routing block side in such a way that terminal strips are formed extending on two longitudinal surfaces of the module housing which face away from one another, the module housing having at least one guide means in a region of its longitudinal extent which guides a plurality of cores from at least one of the sides in such a way that the cores from both sides are guided to their associated terminal strips on the same lateral surface. The contact elements of the terminal strips are preferably designed in the form of insulation displacement contacts having contact ends which are arranged in line or at an angle to one another, an embodiment with a central contact in the form of an isolating contact also being disclosed. In doing so, the central contact and the insulation displacement contacts are shown in planes which are perpendicular to one another.

The invention is based on the technical problem of constructing a distribution strip of the kind described in a more compact manner.

The solution to the technical problem is given by the subject matter with the characteristics of claim 1. Further advantageous embodiments of the invention can be seen from the dependent claims.

For this purpose, the distribution strip for telecommunications and data engineering comprises a housing and core connecting contacts, first core connecting contacts being accessible from a top side of the housing and second core connecting contacts from a bottom side of the housing, the first and second core connecting contacts being part of one-piece first and second contact elements respectively which each comprise a connecting web and a contact leg, a contact leg of a first contact element and a contact leg of a second contact element in each case forming an isolating contact, the core connecting contacts lying in line in one plane, the contact legs being arranged in such a way that the plane of the core connecting contacts is at an acute angle, preferably at an angle of 45° (±5°), to a plane of the contact legs. In this way, the core connecting contacts can be placed against the side surfaces of the housing at an acute angle, preferably at an angle of 45°, and the isolating contacts or contact legs of the isolating contacts are placed parallel to the side surfaces of the housing. The advantage of placing the core connecting contacts, which are preferably designed in the form of insulation displacement contacts, at 45° is the better electrical contact with the cores, whereas the parallel alignment of the contact legs simplifies the insertion of plugs into the isolating contact or isolating contacts. In doing so, the first and second core connecting contacts are arranged in rows in each case.

In a preferred embodiment, the connecting web of a second contact element lies in a plane perpendicular to the plane of the core connecting contacts, the lateral edges of the connecting web cutting the plane of the core connecting contacts at an acute angle α, preferably an angle of 45° (±5°), the contact leg being angled vertically upwards from the connecting web. At the same time, it should be noted that in embodiments where the lateral edges of the connecting web are not parallel, instead of the lateral edges an imaginary center line of the connecting web cuts the plane of the core connecting contacts at an angle α of preferably 45°. This arrangement allows the connecting web to be disposed centrally in the area of the contact leg without the need for the sides to be bent or twisted.

In a further preferred embodiment, the contact leg has a step in its lower region which reduces the width preferably on both sides. At the same time, the lower region of the contact leg is the part facing the connecting web. The step results in a supporting edge for the contact leg, wherein the supporting edge can be relatively wide, as the full width is available because of the arrangement of the connecting web. Preferably, the narrow part of the contact leg is then the same width as the connecting web.

In a further preferred embodiment, the housing consists of a housing top part, a housing middle part and a housing bottom part. The housing middle part results in greater degrees of freedom for definite guiding and stabilizing or supporting of the contact legs.

In a further preferred embodiment, the housing bottom part has supporting surfaces, on the inside of which the contact legs of the second contact elements are laterally supported, two contact legs being supported on one supporting surface in each case, a separating web being arranged centrally on the top of the supporting surface. As a result of this, associated contact legs are supported together in pairs, the clearance and creepage path between the contact legs being limited and at the same time the contact legs being stabilized by the separating web.

In a further preferred embodiment, a side wall of the housing middle part is spaced off by webs so that chambers, through which the contact legs of the second contact elements are fed, are formed between the side wall, the webs and a middle part.

In a further preferred embodiment, a further web, which is laterally offset in a plane with respect to a separating web, is arranged centrally in each chamber on the top edge of the middle part. In each case, a separating web and a further web then form a common boundary for the clearance/creepage path. Preferably, the further webs are therefore the same height as the webs for spacing-off the side wall.

In a further preferred embodiment, the distribution strip includes grounding clips which are clamped between housing top part and housing middle part or housing middle part and housing bottom part. As a result of this, the grounding clips are arranged so that they are captive.

In a further preferred embodiment, housing top part, housing middle part and housing bottom part are clipped together, the clip geometries of housing top part and housing bottom part being matched to one another in such a way that they can also be clipped together without housing middle part.

The invention is described in more detail below with reference to a preferred exemplary embodiment. In the drawings:

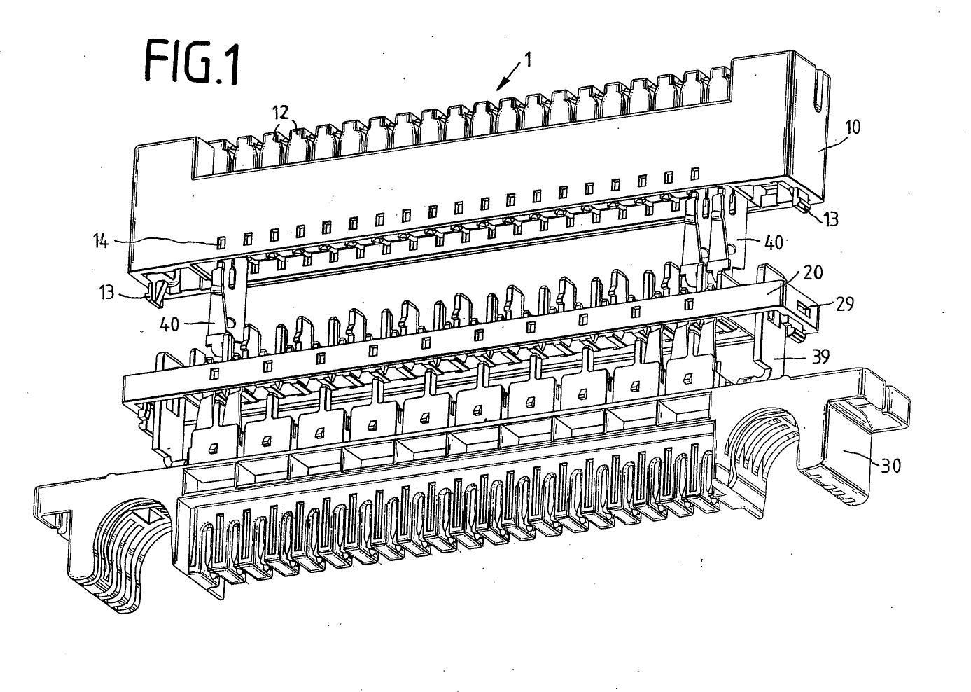

FIG. 1 shows a perspective exploded view of a distribution strip,

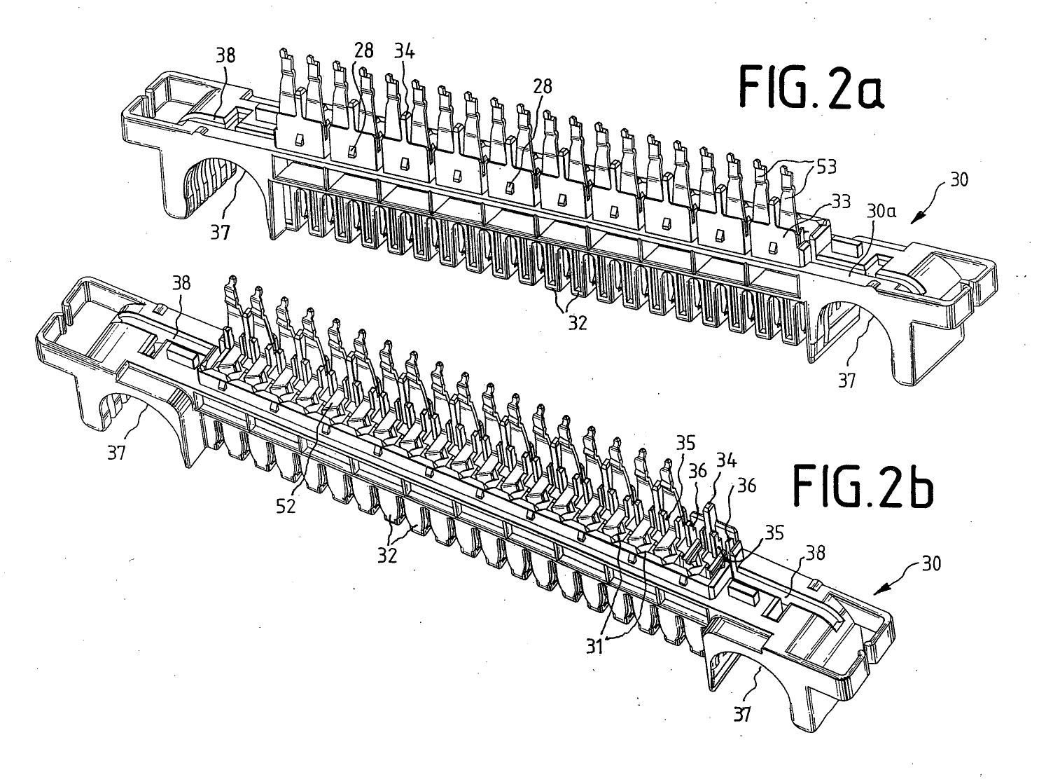

FIG. 2a shows a perspective front view of a housing bottom part with second contact elements inserted,

FIG. 2b shows a perspective back view of the housing bottom part,

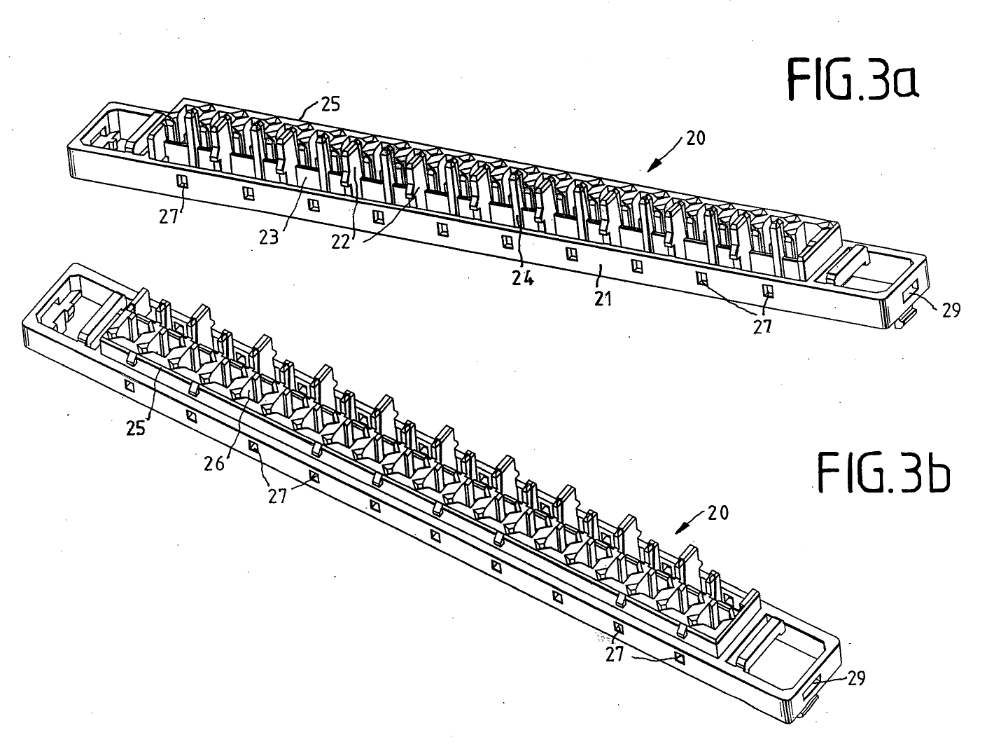

FIG. 3a shows a perspective front view of a housing middle part,

FIG. 3b shows a perspective back view of the housing middle part,

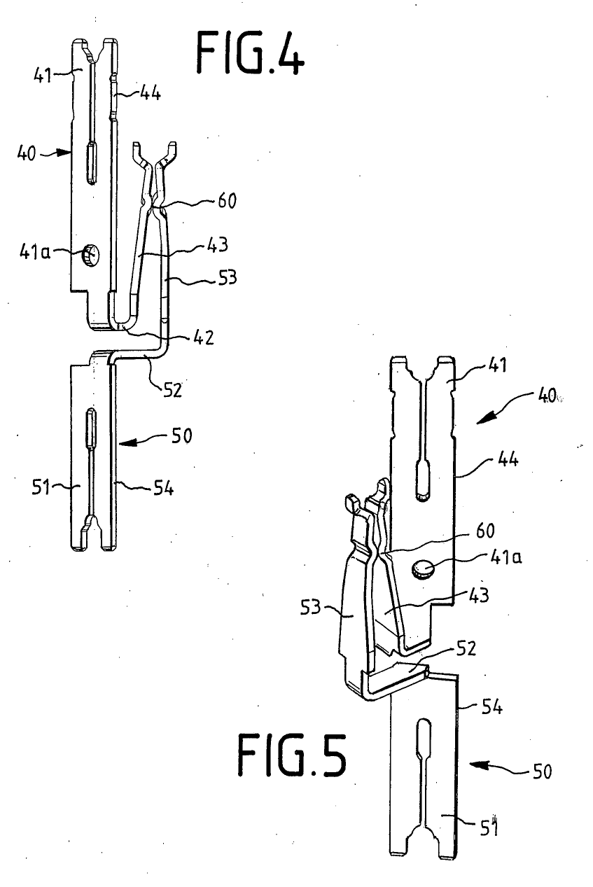

FIG. 4 shows a perspective view of a first and second contact element in a first representation,

FIG. 5 shows a perspective view of a first and second contact element in a second representation,

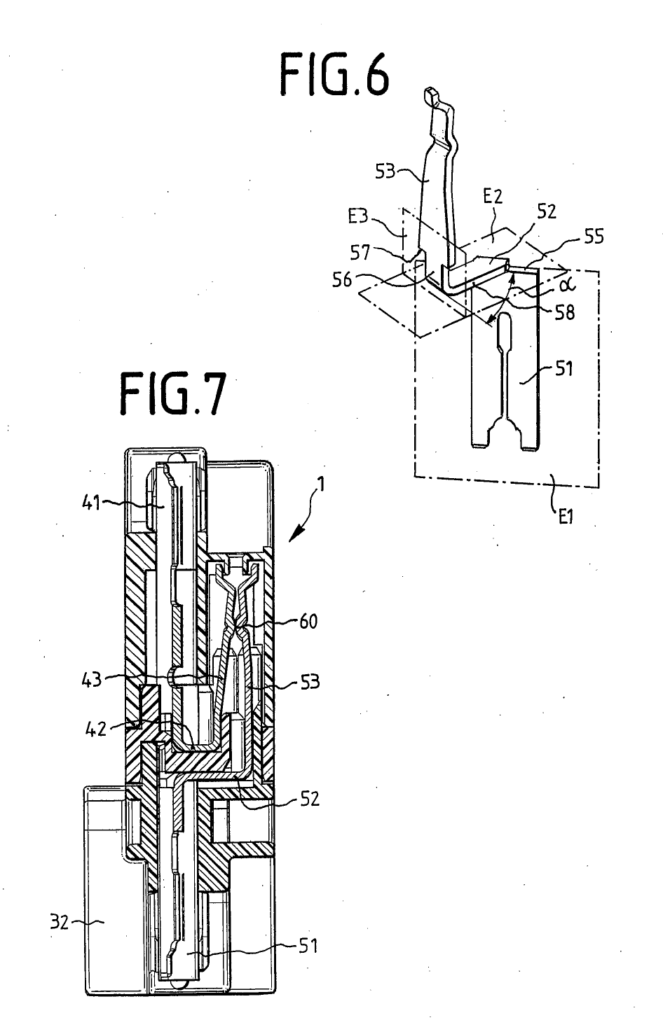

FIG. 6 shows a perspective view of a second contact element,

FIG. 7 shows a sectional view of the distribution strip,

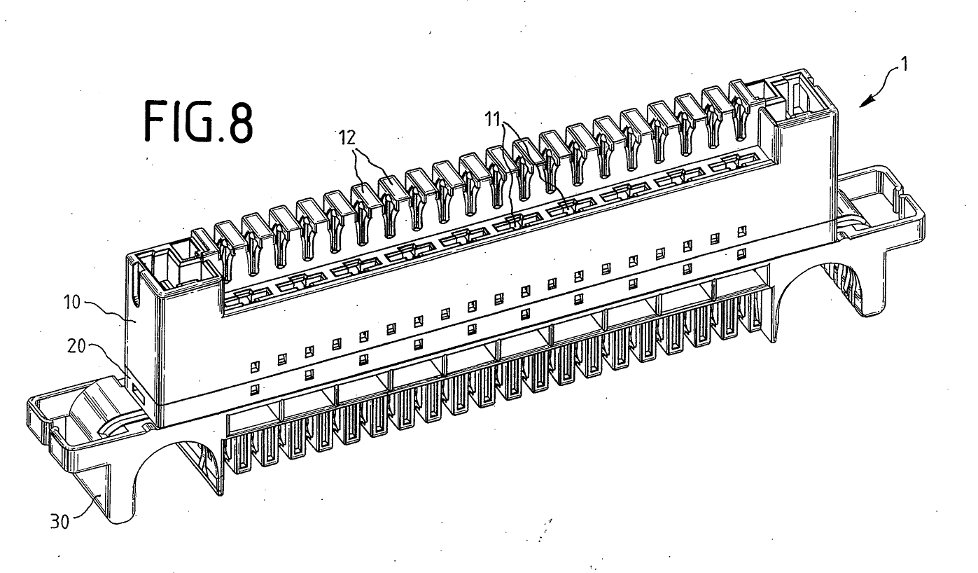

FIG. 8 shows a perspective front view of the assembled distribution strip, and

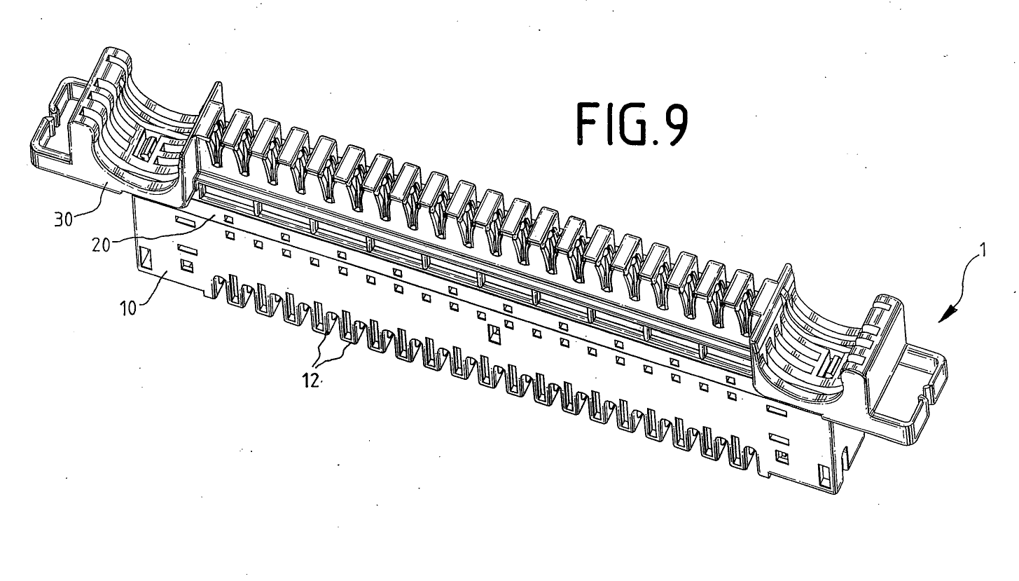

FIG. 9 shows a perspective bottom view of the distribution strip.

The distribution strip 1 comprises a housing top part 10, a housing middle part 20 and a housing bottom part 30. The housing top part 10 accommodates first contact elements 40 and the housing bottom part 30 accommodates second contact elements 50.

Before the structure of the distribution strip 1 is explained further, the structure of the first and second contact elements 40, 50 and the way in which they work is explained in more detail with reference to FIG. 4-6. The first contact element 40 and second contact element 50 are shown in FIGS. 4 and 5 as in their respective positions in the distribution strip 1 (not shown). The first contact element 40 comprises a first core connecting contact 41 in the form of an insulation displacement contact, a connecting web 42 and a first contact leg 43. Correspondingly, the second contact element 50 comprises a second core connecting contact 51 in the form of an insulation displacement contact, a connecting web 52 and a second contact leg 53. The two contact legs 43, 53 together form an isolating contact with an isolating contact point 60. At the same time, the two core connecting contacts 41, 51 lie in a plane E1 (see FIG. 6) and are aligned with one another, which is shown by the dashed center line in FIG. 4, i.e. lateral edges 44, 54 lie in a straight line. The connecting web 42 is shorter than the connecting web 52 and connects the core connecting contact 41 to the contact leg 43. At the same time, the connecting web 42 is bent virtually at right angles away from the contact leg 43, the connecting web 42 being additionally offset by 45° at the transition to the core connecting contact 41. At the same time, the core connecting contact 41 is longer than the core connecting contact 51 to enable the contact leg 43 to be made long enough to have appropriate spring characteristics. Furthermore, a hole 41a can be seen, which among other things reduces the capacitive coupling with an adjacent core connecting contact 41.

After a bend at the contact leg 53, the connecting web 52 of the second contact element 50 runs in a plane E2 which is perpendicular to the plane El of the core connecting contacts 41, 51, and also to the plane E3 of the contact leg 53. At the transition to the core connecting contact 51, the connecting web 52 abuts the bottom edge 55 of the core connecting contact 51 at an angle of 45°, i.e. the plane E1 of the core connecting contact 51 is again turned through 45° with respect to the plane E3 of the contact leg 53. This angle α is shown schematically in FIG. 6 between a lateral edge 58 of the connecting web 52 and the bottom edge 55 of the core connecting contact 51. The contact leg 53 narrows in steps on both sides in the lower region 56 and is exactly the same width as the connecting web 52. As a result, two stop edges 57 for the contact leg 53 are formed above the narrow part to enable it to be supported accordingly in the housing bottom part 30. At the same time, it should be pointed out that the plane which is meant by plane E3 of the contact leg 53 is the plane of the virtually planar sub-section in the lower region 56 and above, so that the bends in the area of the isolating contact point 60 and above do not have to be considered.

The further structure is now first explained in more detail with reference to FIGS. 2a and 2b. The housing bottom part 30 accommodates the second contact elements 50. For this purpose, the housing bottom part 30 has a through opening 31 for each contact element 50 through which the core connecting contact 51 is fed, the core connecting contact 51 in each case lying between two clamping ribs 32 in the inserted state. Supporting surfaces 33 are arranged on the top 30a, a separating web 34 being arranged in each case centrally on the top 30a of the supporting surfaces 33. Two slightly projecting webs 35 corresponding to projecting webs 36 on the lateral edge of the supporting surfaces 33 are arranged on the inside below the separating web 34. When the second contact element 50 is inserted, the contact leg 53 then lies between the supporting surface 33, a web 35 and a web 36 and is therefore securely guided.

At the same time, two contact elements 50 or contact legs 53 are supported on one supporting surface 33 in each case, these being spatially separated from one another by the separating web 34. At the same time, it should be noted that the two contact elements 50 on the right in FIG. 2b have been removed. Furthermore, the housing bottom part 30 has an arc-shaped clip element 37 and a slot 38 on each side. A grounding clip 39 (see FIG. 1), the ring contact of which lies freely in a slot in the arc-shaped clip element 37, can be pushed through the slot 38. This enables a chassis connection to be produced by clipping the housing bottom part 30 onto a round bar.

The housing middle part 20 is shown in FIGS. 3a and 3b. The housing middle part 20 comprises a side wall 21, which is spaced off from a middle part 23 of the housing middle part 20 by webs 22. A through chamber, through which the contact legs 53 are fed when the housing bottom part 30 and the housing middle part 20 are clipped together, is then formed between two adjacent webs 22, the middle part 23 and the side wall 21. A further web 24, which runs inside the chamber on the middle part 23 and has the same height as the webs 22, is in each case arranged centrally between two webs 22. In the assembled state, a separating web 34 and a further web 24 then form a wide common web similar to the web 22. In doing so, the webs 22 or separating webs 34 and further webs 24 limit the clearance and creepage paths between the contact elements 50. Further chambers 26 with a closed bottom, in which the connecting webs 42 of the first contact elements 40 are supported, are arranged between middle part 23 and a housing wall 25. Furthermore, the housing middle part 20 has latching openings 27 in which latching projections 28 arranged on the outsides of the supporting surfaces 33 engage (see FIG. 2a).

A sectional view through the fully assembled distribution strip 1 is shown in FIG. 7, the section line being placed centrally through the isolating contact point 60.

The fully assembled distribution strip 1 is finally shown in perspective in FIGS. 8 and 9. Here, the housing top part 10 has openings 11 by means of which the isolating contact points 60 can be accessed by inserting an isolating plug or an overvoltage protection plug, for example, two isolating contact points 60 in each case being accessible via one opening 11. Furthermore, the housing top part 10 has clamping ribs 12, between which one core connecting contact 41 is arranged in each case, the core connecting contact 41 being placed at 45°.

It can also be seen from FIG. 1 that the housing top part 10 has two latching tongues 13 which engage in latching openings 29 of the housing middle part 20. In embodiments where the housing middle part 20 is omitted, however, housing top part 10 and housing bottom part 30 clip together by means of the latching openings 14. Finally, it should be noted that three first contact elements 40 are shown withdrawn from the housing top part 10 in the diagram shown in FIG. 1.

### LIST OF REFERENCES

1 Distribution strip

10 Housing top part

11 Opening

12 Clamping ribs

13 Latching tongues

14 Latching openings

20 Housing middle part

21 Side wall

22 Web

23 Middle part

24 Web

25 Housing wall

26 Chambers

27 Latching openings

28 Latching projections

29 Latching openings

30 Housing bottom part

30a Top

31 Opening

32 Clamping ribs

33 Supporting surfaces

34 Separating web

35 Web

36 Web

37 Clip element

38 Slot

39 Grounding clip

40 First contact element

41 First core connecting contact

41a Hole

42 Connecting web

43 First contact leg

44 Lateral edge

50 Second contact element

51 Second core connecting contact

52 Connecting web

53 Second contact leg

54 Lateral edge

55 Bottom edge

56 Lower region

57 Stop edges

58 Lateral edge

60 Isolating contact point

E1-E3 Planes

1. A distribution strip for telecommunications and data engineering comprising a housing and core connecting contacts, first core connecting contacts being accessible from a top side of the housing and second core connecting contacts from a bottom side of the housing, the first and second core connecting contacts being part of one-piece first and second contact elements respectively which each comprise a connecting web and a contact leg, a contact leg of a first contact element and a contact leg of a second contact element in each case forming an isolating contact, the core connecting contacts lying in line in one plane, wherein
the contact legs are arranged in such a way that the plane of the core connecting contacts is at an acute angle to a plane of the contact legs.

2. The distribution strip as claimed in claim 1, wherein the connecting web (52) of a second contact element lies in a plane (E2) perpendicular to the plane of the core connecting contacts, the lateral edges of the connecting web cutting the plane of the core connecting contacts at an acute angle, the contact leg being angled vertically upwards from the connecting web).

3. The distribution strip as claimed in claim 1, wherein the contact leg has a step in its lower region which reduces the width.

4. The distribution strip as claimed in claim 1, wherein the housing comprises a housing top part, a housing middle part and a housing bottom part.

5. The distribution strip as claimed in claim 4, wherein the housing bottom part has supporting surfaces, on the inside of which the contact legs of the second contact elements are laterally supported, two contact legs being supported on one supporting surface in each case, a separating web being arranged centrally on the top of the supporting surface.

6. The distribution strip as claimed in claim 5, wherein a side wall of the housing middle part is spaced off by webs so that chambers are formed between the side wall, the webs and a middle part.

7. The distribution strip as claimed in claim 6, wherein a further web, which is laterally offset in a plane with respect to a separating web of the supporting surface, is arranged centrally in each chamber on the top edge of the middle part.

8. The distribution strip as claimed in claim 4, wherein the distribution strip includes grounding clips which are clamped between housing top part and housing middle part or housing middle part and housing bottom part.

9. The distribution strip as claimed in claim 1, wherein housing top part, housing middle part and housing bottom part are clipped together, the clip geometries of housing top part and housing bottom part being matched to one another in such a way that they can also be clipped together without housing middle part.
